(19) United States
(12) Patent Application Publication
(10) Pub. No.: US 2011/0038286 A1
(43) Pub. Date: Feb. 17, 2011

(54) USING FREQUENCY DIVISIONAL MULTIPLEXING FOR A HIGH SPEED SERIALIZER/DESERIALIZER WITH BACK CHANNEL COMMUNICATION

(75) Inventors: Paul Ta, Fremont, CA (US); Wei Wang, San Jose, CA (US)

Correspondence Address: Fogg & Powers LLC/Intersil Americas Inc., 5810 W. 78th Street, Minneapolis, MN, 55439, US

(73) Assignee: INTERSIL AMERICAS INC., Milpitas, CA (US)

(21) Appl. No.: 12/773,115

(22) Filed: May 4, 2010

Related U.S. Application Data
(60) Provisional application No. 61/234,484, filed on Aug. 17, 2009.

(51) Int. Cl. H04L 5/14; H04Q 11/02

(52) U.S. Cl. 370/295; 370/430

(57) ABSTRACT

A system comprising a first serializer/deserializer coupled to a first electronic device and a second serializer/deserializer couple to a second electronic device is provided. The first serializer/deserializer comprises a forward channel driver and the second serializer/deserializer comprises a reverse channel driver. A communication medium is coupled between the first and second serializer/deserializers, and the first and second serializer/deserializers are AC coupled to the communication medium to provide a high frequency forward channel and are DC coupled to the communication medium to provide a low frequency reverse channel.

### CROSS-REFERENCE TO RELATED APPLICATIONS

This application is related to U.S. provisional patent application Ser. No. 61/234,484 (attorney docket number SE-2465) entitled “USING FREQUENCY DIVISIONAL MULTIPLEXING FOR A HIGH SPEED SERIALIZER/DESERIALIZER WITH BACK CHANNEL COMMUNICATION,” filed on Aug. 17, 2009 and referred to herein as the '484 application. The present application hereby claims priority to U.S. Provisional Patent Application No. 61/234,484. The '484 application is hereby incorporated herein by reference.

### DRAWINGS

Embodiments of the present invention can be more easily understood and further advantages and uses thereof more readily apparent, when considered in view of the description of the embodiments and the following figures in which:

FIG. 1 is a block diagram of one embodiment of a system implementing bi-directional communications.

FIG. 2 is a block diagram of one embodiment of a circuit for bi-directional communications.

FIG. 3 is a schematic representation of an embodiment of a reverse channel driver for a serializer/deserializer using frequency division multiplexing.

FIG. 4 is a schematic representation of an embodiment of a circuit for frequency division multiplexing in a serializer/deserializer using a low pass filter.

FIG. 5A is a block diagram of one embodiment of a bi-directional communication system using frequency division multiplexing.

FIG. 5B is a timing diagram of one embodiment of signals transmitted over the system of FIG. 5A.

FIG. 6A is a flowchart of one embodiment of a method 600 for bi-directional communications over a communication medium.

FIGS. 6B and 6C are flowcharts of embodiments of methods for operating a serializer/deserializer.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments described herein disclose a serializer/deserializer (SerDes) that communicates bi-directionally over a communications medium. The SerDes implements an AC coupling and a DC coupling to the communications medium. This SerDes circuit uses a forward channel via the AC coupling to communicate high speed data and a back channel via the DC coupling to communicate low speed data. This AC coupled network creates a frequency band for high speed forward data transmission and a frequency band for low speed reverse data transmission. Frequency division multiplexing (FDM) between high speed signals on the forward channel and low speed signals on the reverse channel provides back channel capability. FDM multiplexes signals into non-overlapping frequency bands so that the signals are recoverable after being transmitted over the same transmission medium. This FDM solution allows the transmitter and the receiver to provide a continuous, dedicated bandwidth for both upstream and downstream transmissions. Embodiments described herein address the limitations that existing serial communication systems face in simultaneously sending data over a forward channel and a back channel.

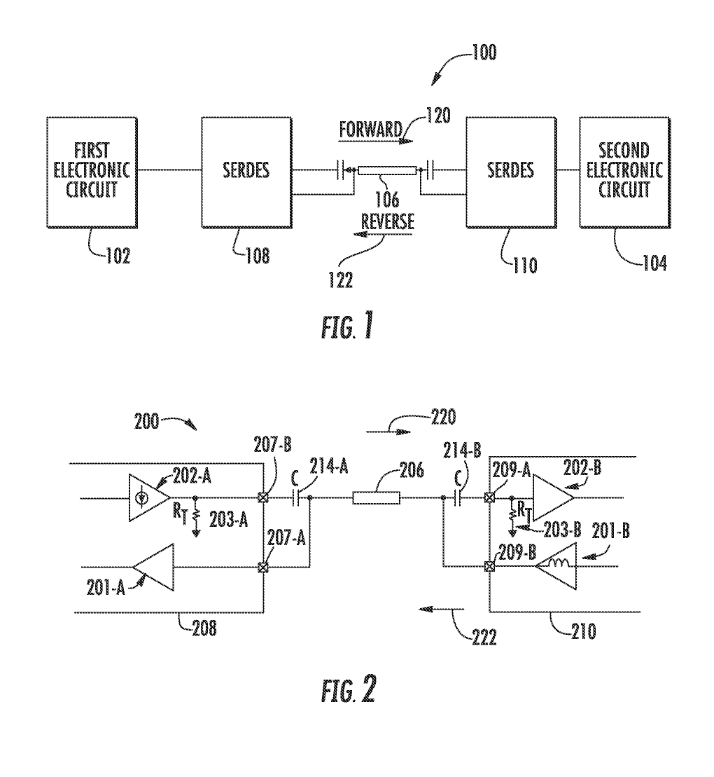

FIG. 1 is a block diagram of one embodiment of a system 100 implementing bi-directional communications. The system 100 comprises a first electronic circuit 102 coupled to a communications medium 106 through a first SerDes 108 and a second electronic circuit 104 coupled to the communications medium 106 through a second SerDes 110. The communication medium 106 functions as a transmission line between the first and second electronic circuits 102 and 104. Embodiments of the communications medium 106 include a wired link such as a cable (for example, a flexible flat cable), circuit board trace, twisted pair or other communication medium. Communication between first and second electronic circuits 102 and 104 is bi-directional over this shared communication medium 106.

Each of serializer/deserializers 108 and 110 is coupled to communication medium 106 in two ways to achieve bi-directional communication. First, each of SerDes 108 and 110 is AC coupled to the communication medium 106 with a termination resistor and a coupling capacitor to establish a forward channel 120 for communications from the first electronic circuit 102 to the second electronic circuit 104. The forward path 120 typically transmits higher speed communication, for example, video data between a video source and video display screen. The AC coupling capacitor and termination resistor creates an AC coupling network that isolates signals to be communicated within the higher frequency band.

Second, each of serializer/deserializers 108 and 110 is DC coupled directly to communication medium 106 to establish a reverse channel 122 for communication of data from the second electronic circuit 104 to the first electronic circuit 102. This reverse channel 122 is typically transmits lower speed signals, for example, control information or DC power signals.

The first electronic circuit 102 is coupled to the SerDes 108 via a parallel interface. The SerDes 108 serializes data received from the first electronics circuit 102 before sending the data over the forward channel 120 of the communication medium 106. Serializing a high speed parallel data signal results in a high frequency serial data signal. Embodiments of the serial data signal contain an embedded clock signal. Other embodiments of the serial data signal comprise a low speed data signal (such as a control signal) that has been converted into a high frequency packet. In addition to the data signal information, the high frequency packet comprises a control bit (for example, a speed bit) that indicates to the receiver (for example, SerDes 110) to interpret the high frequency packet as a low speed signal.

Upon receipt of a high frequency data signal from the forward channel 120, SerDes 110 deserializes the signal and provides the deserialized signal to the second electronic circuit 104. The SerDes 110 typically receives a low speed data signal from the second electronics circuit 104. Similarly, SerDes 110 serializes the low speed data signal from the second electronics circuit 104 before sending the signal over the communication medium 106 on the reverse channel 122. Serializing the low speed data signal results in a low frequency data signal. Subsequently, SerDes 108 deserializes data it receives over the reverse path 122.

This frequency division multiplexing (FDM) approach enables bi-directional communications over the communication medium 106. That is, SerDes 108 and SerDes 110 simultaneously send data over a forward channel 120 and a reverse channel 122, respectively, without substantial interference. High speed signals sent on the forward channel 120 are within a first frequency band and low speed signals sent on the reverse channel 122 are within a second frequency band. In one embodiment, the second frequency band does not overlap with the first frequency band.

FIG. 2 is a block diagram of one embodiment of a circuit 200 for bi-directional communications. A first SerDes 208 sends data through the communications medium 206 over a forward channel 220 to a second SerDes 210. The SerDes 210 sends data through the communications medium 206 over a reverse channel 222. The SerDes 210 is also referred to as a high speed data receiver because it receives high speed data from the SerDes 208. The SerDes 210 uses an inductor emulator as a reverse channel driver 201-B to limit communications over the reverse channel 122. Other techniques for limiting communications over the back channel 122 are contemplated.

The SerDes 208 comprises a forward channel driver 202-A, a terminator resistor 203-A with resistance R_{T}, and a receiver 201-A. The SerDes 208 is coupled to the communications medium 206 at an input 207-A and at an output 207-B. The output 207-B connects the termination resistor 203-A to a first side of an AC coupling capacitor 214-A. The AC coupling capacitor 214-A, together with the termination resistor 203-A, creates a high pass transfer function. The AC coupling network blocks low frequency signals, therefore, the SerDes 208 can send only high frequency signals onto the communications medium 206. The input 207-A connects the input of the receiver 201-A to a second side of the AC coupling capacitor 214-A. This forms a DC coupling that bypasses the AC coupling capacitor and forms part of the reverse channel 222. The DC coupling enables the receiver 201-A to receive low frequency signals from the SerDes 210.

The SerDes 210 comprises a reverse channel driver 201-B, a terminator resistor 203-B with resistance R_{T}, and a receiver 202-B. The SerDes 210 is AC coupled to the communications medium 206 at an input 209-A. The input 209-A connects the termination resistor 203-B to a first side of an AC coupling capacitor 214-B. The AC capacitor 214-B, together with the termination resistor 203-B, also creates a high pass transfer function that allows high frequency signals to be passed.

The SerDes 210 is DC coupled to the communications medium 206 at an output 209-B. The output 209-B connects the output of the reverse channel driver 201-B to a second side of the AC coupling capacitor 214-B to create the reverse channel 222.

The AC coupling capacitors 214-A and 214-B enable the circuit 200 to utilize frequency division multiplexing, which enables bi-directional transmission across the communications medium 206. The forward channel 220 passes relatively high frequency signals output by the forward channel driver 202-A through the AC coupling capacitor 214-A, which are transmitted through the communications medium 206, and passed through the AC coupling capacitor 214-B to be received by the receiver 202-B. On the reverse channel 222, the reverse channel driver 201-B passes relatively low frequency signals, which bypass the AC coupling capacitor 214-B through DC coupling, are transmitted through the communications medium 206, bypass the AC coupling capacitor 214-A, and received by receiver 201-A through DC coupling.

Signal integrity of high speed serial links such as with communications medium 206 are affected by reflections due to impedance mismatches along the signal path, signal attenuation from backplane materials, added noise due to crosstalk and inter symbol interference. Signal integrity is improved in different ways. For example, the termination resistors 203-A and 203-B reduce unwanted reflections on the communications medium 206 and improve the quality of the signals. In other embodiments of the circuit 200, the termination resistors 203-A and 203-B are placed externally to the SerDes 208 and 210, respectively. In yet other embodiments, the resistance of the termination resistor 203-A is approximately equal to the resistance of the termination resistor 203-B. In further embodiments of the circuit 200, the resistance of termination resistor 203-A does not equal the resistance of the termination resistor 203-B.

Data transfer rates on the forward channel 220 are typically higher than on the reverse channel 222. Exemplary data transfer rates of the circuit 200 include approximately 100 Mb/s to 1600 Mb/s on the forward channel 220 and approximately 1 Mb/s on the reverse channel 222; however, other embodiments of the circuit 200 employ different data rates. Embodiments of the circuit 200 contain power spectral density (PSD) of the signals on the reverse channel 222 to a low frequency band in order to maintain the signal quality of the forward channel 220.

Decreasing the bandwidth of the reverse channel 122 also increases signal integrity on the forward channel 120, for example, by decreasing jitter (Tⱼ). Jitter is proportional to the −3 dB cutoff frequency of the AC coupling network. Jitter in the forward channel 120 can be found as:

$${T}_{j} \approx \frac{{T}_{rf} \cdot T \cdot N}{R \cdot C} \qquad ( Eq . 1 )$$

where T_{rf} is the rise/fall time of the signal, T is the high speed bit time, N is the maximum run length, R is the resistance of the termination resistor, and C is the AC coupling capacitance. The maximum run length (N) is a predetermined number of how many consecutive identical bits are allowed. For example, the SerDes's 108 code bounds the number of consecutive 0s or 1s that can be transmitted.

In addition to jitter, the circuit 200 is also subject to near end crosstalk. Crosstalk (also referred to herein as echo) is noise related to the coupling of signals on the forward channel 220 and the reverse channel 222. The intensity of crosstalk depends on a number of factors, including signal amplitude, signal frequency, and the length of the communications medium 206. The higher the frequency of the signal on the reverse channel, the more crosstalk occurs.

In some embodiments using larger bandwidth (for example, when the data rate on the back channel 222 is relatively high), the PSD of the reverse channel 222 overlaps the PSD of the forward channel 220. Overlapping PSDs increase crosstalk. Thus, when a larger bandwidth is used for the reverse channel 222, implementing a form of low frequency crosstalk canceller in the high speed data receiver (such as SerDes 210) reduces crosstalk.

The AC coupling network provides some protection against crosstalk because low frequency data is not transmitted over the forward channel 220. The output of the high speed data receiver (such as circuit 104) is low pass filtered. The signal low frequency signal content is referred to as a low frequency envelope, which is subtracted from the inputs of the high speed data receiver to further reduce crosstalk. However, some crosstalk may be left due to a phase delay from the low pass filter. Another embodiment of circuit 200 reduces crosstalk after power up. An echo path transfer function is measured while sending out a single tone data in the absence of traffic on the high speed forward channel 220. In this embodiment, a filter with an adjustable amplitude and phase is used to cancel the measured echo path during normal bi-directional communications.

Data is typically DC balanced encoded and AC coupled for transmission in gigabit data rate SerDes applications. DC balancing creates a balanced data pattern (that contains equal numbers of 0's and 1's) to provide guaranteed clock transitions synchronization for the receiver circuitry, as well as maintaining an even power value on the line. DC balancing and AC coupling ease the data transmission when the transmitter and the receiver have different ground references.

The AC coupling capacitors 214-A and 214-B further enable the SerDes 108 and 110 to be located remote from each other. That is, the AC coupling capacitors 214-A and 214-B enable the SerDes 108 and 110 to use separate ground systems. The SerDes 108 can be located anywhere up to approximately 100 meters remote from the SerDes 110. In other embodiments of the circuit 200, the SerDes 108 is located at any distance from the SerDes 110, limited by factors that reduce signal integrity, such as attenuation, crosstalk, the closeness of the low frequency band to the high frequency band, etc. The AC coupling creates the high and low frequency bands.

FIG. 3 is a schematic representation of an embodiment of a reverse channel driver 300 for a serializer/deserializer using frequency division multiplexing. The reverse channel driver 300 functions as an inductor emulator to limit communications over a reverse channel. Impedance of the reverse channel driver 300 is low at low frequency and high at high frequency. High impedance at high frequencies reduces the possibility of loading down traffic on the forward channel (such as forward channel 220) which is usually at high speeds (for example, in the GHz range). In other words, the output impedance of the reverse channel driver 300 is high so only relatively low frequency signals are passed and transmitted over the reverse channel (such as reverse channel 222) and relatively high frequency signals are blocked. This reduces the transmission of high frequency signals which could interfere with the data on the forward channel.

The reverse channel driver 300 comprises transconductance amplifiers 312-1 through 312-4 that output a current proportional to their input voltage. Transconductance amplifiers 312-1 and 312-2, as well as transconductance amplifiers 312-3 and 312-4, are in a back-to-back parallel configuration. The back-to-back parallel configuration creates a floating two terminal inductance that achieves the impedance enabling low frequency signals to be passed. In one embodiment, some or all of the integrators 312-1 through 312-4 are Gm integrators.

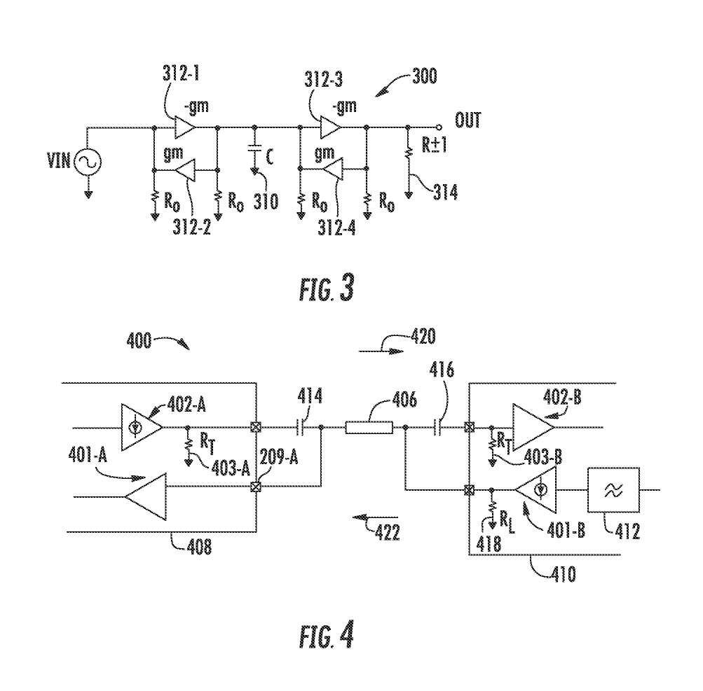

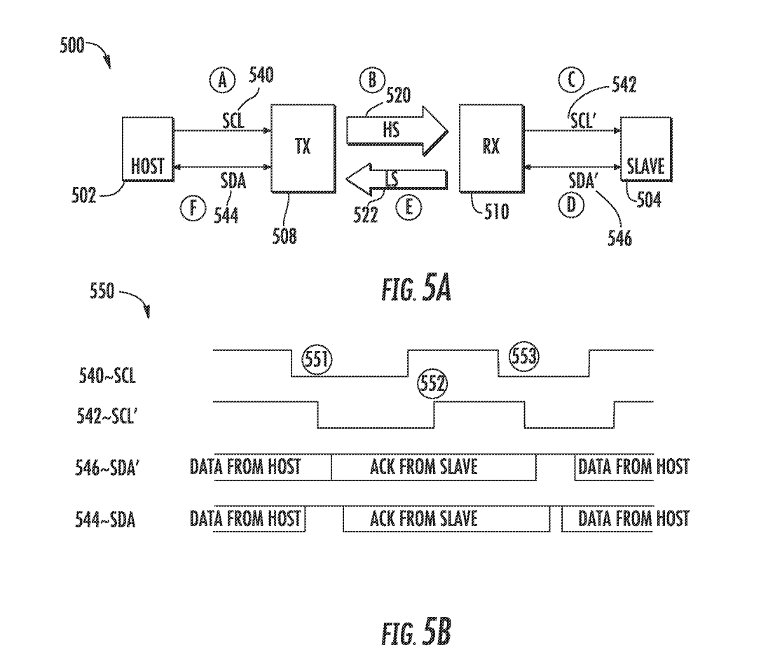

One embodiment of the reverse channel driver 300 has impedance (Z) that is low and flat in a low frequency band. A reverse channel driver 300 with these characteristics efficiently drives the low speed data on the communication medium 206. In the high frequency band, the impedance of the reverse channel driver 201-B is high so that it will not load down the high speed data in the forward channel. High impedance also reduces high frequency harmonics coming off a pre-driver (for example, filter 412 in FIG. 4) from getting through the AC coupling network, which would further degrade the quality of the high speed data. The output impedance (Zₒᵤₜ) of the reverse channel driver 300 is given by:

$$\begin{matrix}{Z}_{out} = \frac{{R}_{1} ( 1 + \frac{1}{2} {SC}_{ind} {R}_{0} )}{1 + \frac{1}{2} {G}_{m}^{2} {R}_{1} {R}_{0} + \frac{1}{2} {SC}_{ind} {R}_{0}} & ( Eq . 2 ) \\ {F}_{zero} = \frac{- 1}{\frac{1}{2} {C}_{ind} {R}_{0}} & ( Eq . 3 ) \\ {F}_{pole} = \frac{- ( 1 + \frac{1}{2} {G}_{m}^{2} {R}_{1} {R}_{0} )}{\frac{1}{2} {C}_{ind} {R}_{0}} & ( Eq . 4 )\end{matrix}$$

F_{zero} is a predefined frequency where a percentage of a signal is gained (for example, 30% of signal gain). Fₚₒₗₑ is the pole frequency, a predefined frequency when a level of attenuation begins to occur, for example 30% of signal loss. C_{ind} is the capacity of an inductor capacitor 310, Gₘ is the transconductance of the transconductance amplifiers 312-1 through 312-4, R₀ is the resistance of the resistors 314-1 through 314-4, R₁ is the resistance of resistor 314, and S is a complex value of angular frequency.

At low frequency, Zₒᵤₜ≈2(Gₘ²Rₒ) and at high frequency, Zₒᵤₜ≈R₁. Impedance is low at low frequency (that is, near F_{zero}) and rises as the frequency approaches Fₚₒₗₑ. In one embodiment of the reverse channel driver 300, Zₒᵤₜ is set to 100 ohm or less at high frequency and is set to 10 k ohm at low frequency. In another embodiment, the bandwidth for the reverse channel 222 is ≦F_{zero} and the bandwidth for the forward channel 220 is ≧Fₚₒₗₑ. The zero of Zₒᵤₜ can be tuned in conjunction with the high pass −3 dB frequency of the AC coupling network.

FIG. 4 is a schematic representation of another embodiment of a circuit 400 for frequency division multiplexing in a serializer/deserializer using a low pass filter 412. The circuit 400 comprises a first SerDes 408 coupled to a communications medium 406 via a first coupling capacitor 414 and a second SerDes 410 coupled to the communication medium 406 via a second coupling capacitor 416. The first SerDes 408 comprises a forward channel driver 402-A coupled to a termination resistor 403-A and a receiver 401 A. The second SerDes 410 comprises a receiver 402-B coupled to the coupling capacitor 416 and a termination resistor 403-B. The second SerDes 410 also comprises a reverse channel driver 401-B coupled to a resistor 418 and a low pass filter 412.

The low pass filter 412 functions as a pre-driver and enables the impedance of the reverse channel driver 401-B to remain constant or nearly constant. The low pass filter 412 allows low frequency signals to be transmitted over a reverse channel 422. The frequency band of the low pass filter 412 can be selected based on the frequency of the multiplexed signals for transmission over the reverse channel 422. One embodiment of the circuit 400 includes a high pass filter in place of the low pass filter 412. In this embodiment, the reverse channel 422 has a higher frequency than the forward channel 420.

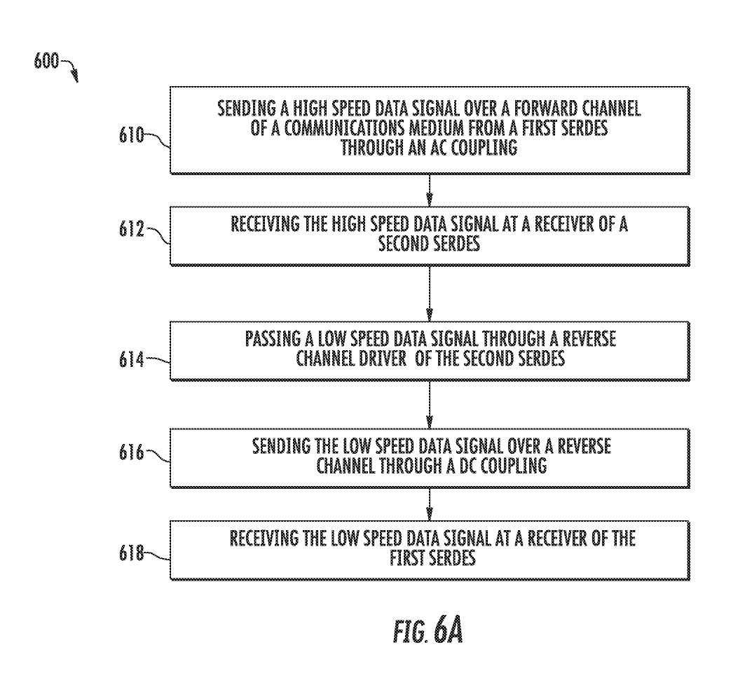

FIG. 5A is a block diagram of one embodiment of a system 500 using frequency division multiplexing with a bi-directional bus. A host device 502 is coupled to a transmitter SerDes 508, which transmits data to a receiving SerDes 510 via a high speed serial link 520. The receiving SerDes 510 is coupled to a slave device 504, and transmits data to the transmitting SerDes 508 via a low speed serial link 522. The host device 502 provides a clock signal over SCL 540 to the transmitting SerDes 508. Control data is communicated bi-directionally over a serial data line (SDA) 544 between the host device 502 and the transmitting SerDes 508. The transmitting SerDes 508 packs (that is, combines) and serializes the signals on SCL 540 and SDA 544 and transmits the combined signal over the high speed serial link 520.

The receiving SerDes 510 extracts the clock signal from the combined signal. The clock signal is sent over SCL′ 542 and the data signal is sent over SDA′ 546 to the slave device 504. The slave device 504 sends low speed data (such as DC power, an acknowledgment, or a control signal) to the receiving SerDes 510 over SDA′ 546. The receiving SerDes 510 serializes the low speed data and sends it over the low speed serial link 520. In some embodiments, the receiving SerDes 510 is on the same chip as the slave device 504 or even comprises the slave device 504. In another embodiment, the high speed serial link 520 and the low speed serial link 522 are both formed over a single communication medium, such as a single pair of cable.

FIG. 5B is a timing diagram of one embodiment of signals 550 transmitted over the system 500 of FIG. 5A. The timing functionality of the system 500 is illustrated with respect to points A through F shown in FIG. 5A. From point A to point B, the SCL 540 and SDA 544 are over-sampled and interpreted by the transmitting SerDes 508. The transmitting SerDes 508 packs the interpreted information into a packed signal to send over the high speed data link 520. Latency can be experienced between points A and B (for example, tens of byte clock cycles). If either SCL 540 or SDA 544 is slower than the high speed data link 520, the system 500 has time to wait for a specific time slot to pack the SCL 540 and SDA 544 information.

The propagation delay of the transmission from the transmitting SerDes 508 to the receiving SerDes 510 at point B is taken into account to later extract an accurate clock signal. From point B to point C, the receiving SerDes 510 unpacks the SCL 540 and SDA 544 information and forwards it to the slave device 504. In one embodiment, the receiving SerDes 510 tristates its SDA driver at the end of this time period (the latency may be tens of byte clock cycles). The slave device 504 responds to the receiving SerDes 510 with an acknowledgement signal (ACK), a control signal, or any other suitable example.

From point D to E, the receiving SerDes 510 reads SDA′ 546 and sends it over the low speed data link 522. At this time, the latency can be small (for example, only several byte clock cycles). Again, at point E, the propagation delay over the low speed data link 522 is taken into account. From point E to F, the transmitting SerDes 508 receives the low speed data link 522 data stream and drives SDA 544 accordingly. Here, the latency can also be small (for example, several byte clock cycles).

In one embodiment, the low speed data link 522 is powered on continuously while the system 500 is powered up. Thus a handshake protocol can be implemented in the side traffic. For example, in an I²C bus protocol (a bi-direction protocol for slow speed control), the slave device 504 holds the clock signal low while requesting the host 502 temporarily stall transactions. At point 552 in FIG. 5B, the transmitting SerDes 508 holds SCL 540 low, meanwhile the receiving SerDes 510 controls the timing (programmable by user) of SCL′ 542 independently to the timing of SCL 540 at the transmitting SerDes 508 side in order to implement an ACK signal.

Exemplary embodiments of the host device 502 and the slave device 504 comprise a host processor and a graphics display for use in a cellular phone. The host processor sends graphics signals to be displayed on the graphics display over the forward channel high speed data link 520. The host processor also sends low speed control signals to the graphics display packaged as high speed data. The graphics display (for example, a liquid crystal display (LCD) screen or other panel screen) sends acknowledgement signals or other low speed signals to the host processor over the reverse channel low speed data link 522. In this embodiment, the graphics signals require a much higher data throughput than the ACK signals; thus the graphics signals are sent over the high speed data link 520 and the ACK signals are sent over the low speed data link 522.

Because the graphics display is often on an opposite side than the host processor is in a cell phone, the communication medium (such as communication medium 106) is physically limited by how many wires can pass through the hinge or pivot. A serial flex cable or the like is used to compensate for the physical constrictions in the mechanical connection. In another example, a cell phone camera is also located on the opposite side of the host processor. In this embodiment, the camera sends high speed image data to the host processor, and the host processor sends low speed control data or DC power signals to the camera. Thus, embodiments of a cell phone include two circuits (such as two circuits 200), where a first circuit couples a host processor to a graphics display (with the graphics display on the high speed receiver side) and a second circuit couples a camera to the host processor (with the host processor on the high speed receiver side).

One embodiment of a first and second electronic circuit (such as electronic circuits 102 and 104) implement the I²C protocol. For example, an I²C master on the host processor fans out information to control the camera, brightness, zoom, or other functions of a camera cell phone. This information is transmitted over the I²C bus as high speed data over the high speed data link 520. With FDM, the I²C signals and the graphics content are transmitted simultaneously over the same single pair of wires.

The graphics display receives the I²C signal, interprets it, and performs control functions (for example, zoom, etc) on either the receiving SerDes 510 chip or on another slave peripheral 504 (like a camera chip). After the function is performed, the receiving SerDes 510 sends back an ACK signal over the low speed data link 522. In other words, I²C facilitates transport such that the same physical medium of a single pair flex wire has a forward video data (serialization) and bi-directional transportation of I²C control signals. The “ACK” bit of I²C bus is just one example; any bi-directional bus or protocol may be used in the system 500.

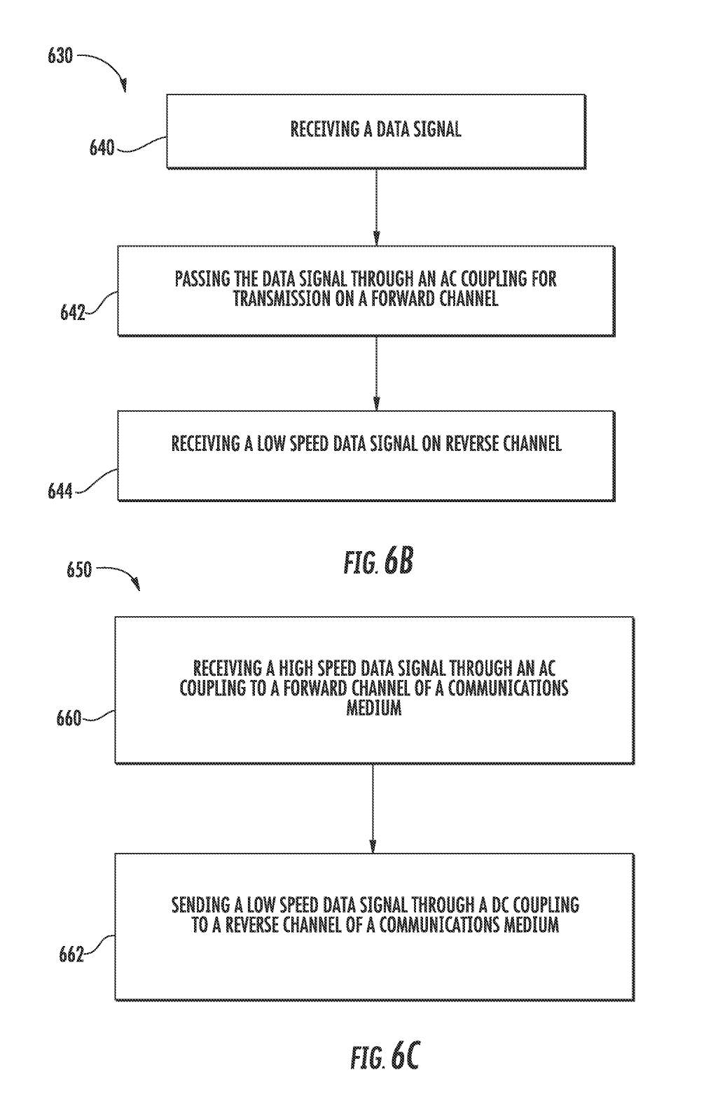

FIG. 6A is a flowchart of one embodiment of a method 600 for bi-directional communications over a communication medium. The method 600 begins with sending a high speed data signal over a forward channel of a communications medium from a first SerDes, wherein a forward channel driver of the first SerDes is AC coupled to the communications medium (block 610). For example, a high speed data signal (such as an image signal) is sent from SerDes 208 over forward channel 220 of communication medium 206. Embodiments of the data signal comprise an information signal and a clock signal that the first Serdes packs into a single high speed data signal.

The method 600 further comprises receiving the high speed data signal at a receiver of a second SerDes, wherein the receiver of the second SerDes is AC coupled to the communications medium (block 612). A low speed data signal is passed through a reverse channel driver of the second SerDes (block 614). For example, the reverse channel driver 300 or the low pass filter 412 pass the low speed data signal because it has low frequency. The low speed data signal is sent over a reverse channel of the communications medium from the reverse channel driver, wherein the reverse channel driver is DC coupled to the communications medium (block 616). The first SerDes receives the low speed data signal, wherein the first SerDes is DC coupled to the communications medium (block 618).

FIG. 6B is a flowchart of one embodiment of a method 630 for operating a serializer/deserializer. The method 630 begins with receiving a data signal (block 640). For example, SerDes 208 receives the data signal from first electronic circuit 102. The data signal can be a parallel high speed data signal or a low speed data signal. When the data signal is a parallel signal, the SerDes serializes the data signal into a high frequency signal, wherein a frequency of the high frequency signal is within a first frequency band. When the data signal is a low speed signal (such as a control signal), the method 630 packetizing the data signal into a high frequency data packet containing a low speed indicator. Packing is a process that groups data into a predetermined packet. The data signal or high frequency data packet is passed through an AC coupling for transmission on a forward channel of a communications medium (block 642). The method 630 continues with receiving a low speed data signal on a reverse channel of the communications medium through a DC coupling to the communications medium (block 644).

FIG. 6C is a flowchart of one embodiment of a method 650 for operating a serializer/deserializer. In one embodiment, the method 650 is performed by a high speed receiving SerDes (such as SerDes 210). The method 650 comprises receiving a high speed data signal at a receiver from a forward channel of a communications medium, wherein the receiver is AC coupled to the communications medium at an input of the serializer/deserializer (block 660). Embodiments of the high speed data signal are sent from another SerDes coupled to the communications medium (such as SerDes 208), and includes high speed signals (such as graphics signals) or low speed data with a speed control indicator. The method 662 also comprises sending a low speed data signal with a reverse channel driver over a reverse channel of the communications medium, wherein the reverse channel driver is DC coupled to the communications medium at an output of the serializer/deserializer (block 662).

Other embodiments of the method 650 comprise receiving a data signal from an electronic device for transmission over the reverse channel, passing the data signal through the reverse channel driver when the data signal has a frequency below a predetermined frequency, and blocking the data signal from transmission over the communications medium when the data signal above the predetermined frequency.

Thus, a forward channel and a reverse channel carry data in different frequency bands (forward in a higher band and reverse in a lower frequency band) between first and second electronic circuits over the same communication medium using a simple, cost-effective technique to separate the bands. Embodiments described herein establish secondary bi-directional side traffic (for example, control signals) via the same serial link of the primary high speed unidirectional data flow. FDM is used to create the bi-directional communications. Embodiments achieve a simple design using an inductor only on the reverse side.

The embodiments described herein are performed while a driver and a receiver are both powered on or when they turn on and off alternatively. Embodiments are also used in applications that do not have blanking times. Embodiments described herein allows continuous spread spectrum in a forward channel. Utilizing FDM in the serializer/deserializers enables a fast data rate. Signal integrity can be maintained using filters or a low frequency crosstalk canceller. Embodiments described herein are applicable to a wide variety of systems, including but not limited to, video display systems (such as cell phones, personal video devices, etc.), navigation systems, video entertainment systems, industrial computing terminals, remote cameras, or any other suitable application.

A number of embodiments of the invention defined by the following claims have been described. Nevertheless, it will be understood that various modifications to the described embodiments may be made without departing from the spirit and scope of the claimed invention. Features and aspects of particular embodiments described herein can be combined with or replace features and aspects of other embodiments. Accordingly, other embodiments are within the scope of the following claims.

What is claimed is:

1. A system, comprising:
a first electronic device;
a second electronic device;
a first serializer/deserializer comprising a forward channel driver, wherein the first serializer/deserializer is coupled to the first electronic device;
a second serializer/deserializer comprising a reverse channel driver, wherein the second serializer/deserializer is coupled to the second electronic device;
a communication medium coupled between the first and second serializer/deserializers; and
wherein the first and second serializer/deserializers are AC coupled to the communication medium to provide a high frequency forward channel and are DC coupled to the communication medium to provide a low frequency reverse channel.

2. The system of claim 1, further comprising:
a first AC coupling capacitor coupling the first serializer/deserializer to the communications medium; and
a second AC coupling capacitor coupling the second serializer/deserializer to the communications medium.

3. The system of claim 1, wherein the reverse channel driver comprises an inductor emulator.

4. The system of claim 3, wherein the inductor emulator has a high impedance at a high frequency and a low impedance at a low frequency.

5. The system of claim 3, wherein the inductor emulator comprises at least one transconductance amplifier.

6. The system of claim 1, wherein the second serializer/deserializer further comprises a low pass filter, wherein the low pass filter functions as a pre-driver.

7. The system of claim 1, wherein a bandwidth for the first frequency band is greater than or equal to a frequency pole and a bandwidth for the second frequency band is less than or equal to a frequency zero.

8. The system of claim 1, wherein the communications medium is one of a cable, a circuit board trace, and a twisted pair.

9. The system of claim 1, further comprising:
wherein the first electronic device is a host processor, wherein the host processor provides a high speed graphic signal to the first serializer/deserializer over the forward channel; and
wherein the second electronic device is a display device, wherein the display device provides an acknowledgement signal to the second serializer/deserializer over the reverse channel.

10. The system of claim 9, wherein the first serializer/deserializer transmits a low speed signal to the second serializer/deserializer as a high frequency signal packet with a speed control bit.

11. The system of claim 1, wherein the second serializer/deserializer comprises a filter with adjustable amplitude and phase, wherein the filter cancels a measured echo path.

12. The system of claim 1, wherein the second serializer/deserializer transmits DC power signals to the first serializer/deserializer over the reverse channel.

13. The system of claim 1, wherein the first and second electronic devices implement an I²C protocol.

14. A serializer/deserializer, comprising:
a forward channel driver configured to receive a data signal from an electronic circuit, wherein the forward channel driver transmits the data signal over a forward channel of a communications medium;
a termination resistor coupled to the forward channel driver, wherein the termination resistor is configured to AC couple to the communications medium through an AC coupling capacitor; and
a receiver for receiving reverse channel communications, wherein the receiver is configured to DC couple to the communications medium.

15. The serializer/deserializer of claim 14, further comprising:
wherein the data signal is a low speed data signal; and
wherein the serializer/deserializer is configured to pack the low speed data signal into a high frequency data packet and send the high frequency data packet over the communications medium.

16. A serializer/deserializer, comprising:
a reverse channel driver configured to send data over a reverse channel of a communications medium, wherein the reverse channel driver is configured to DC couple to the communications medium;
a receiver for receiving communications from a forward channel of the communications medium, wherein the receiver is configured to AC couple to the communications medium; and
a termination resistor coupled to the receiver.

17. The serializer/deserializer of claim 16, wherein the reverse channel driver is an inductor emulator.

18. The serializer/deserializer of claim 17, wherein the inductor emulator comprises at least two Gₘ integrators configured back-to-back and in parallel.

19. The serializer/deserializer of claim 17, wherein the impedance of the inductor emulator is low at low frequency and high at high frequency.

20. The serializer/deserializer of claim 16, further comprising:
a low pass filter, wherein the low pass filter functions as a pre-driver and is coupled to an input of the reverse channel driver.

21. The serializer/deserializer of claim 16, further comprising a low frequency crosstalk canceller.

22. A method of operating a serializer/deserializer, comprising:
receiving a data signal;
passing the data signal through an AC coupling for transmission on a forward channel of a communications medium; and
receiving a low speed data signal on a reverse channel of the communications medium through a DC coupling to the communications medium.

23. The method of claim 22, further comprising:
serializing the data signal into a high frequency signal, wherein a frequency of the high frequency signal is within a first frequency band; and
wherein the low speed data signal has a frequency within a second frequency band, wherein the second frequency band is lower than the first frequency band.

24. The method of claim 22, wherein the data signal comprises a low speed data signal and a low speed indicator.

25. A method of operating a serializer/deserializer, comprising:
receiving a high speed data signal at a receiver from a forward channel of a communications medium, wherein the receiver is AC coupled to the communications medium at an input of the serializer/deserializer; and
sending a low speed data signal with a reverse channel driver over a reverse channel of the communications medium, wherein the reverse channel driver is DC coupled to the communications medium at an output of the serializer/deserializer.

26. The method of claim 25, further comprising:
receiving a data signal from an electronic device for transmission over the reverse channel;
passing the data signal through the reverse channel driver when a frequency of the data signal is below a predetermined frequency; and
blocking the data signal from transmission over the communications medium when the frequency of the data signal is above the predetermined frequency.

27. A method for bi-directional communications over a communication medium, comprising:
sending a high speed data signal over a forward channel of a communications medium from a first serializer/deserializer, wherein a forward channel driver of the first serializer/deserializer is AC coupled to the communications medium;
receiving the high speed data signal at a receiver of a second serializer/deserializer, wherein the receiver of the second serializer/deserializer is AC coupled to the communications medium;
passing a low speed data signal through a reverse channel driver of the second serializer/deserializer;
sending the low speed data signal over a reverse channel of the communications medium from the reverse channel driver, wherein the reverse channel driver is DC coupled to the communications medium; and
receiving the low speed data signal at a receiver of the first serializer/deserializer, wherein the receiver of the first serializer/deserializer is DC coupled to the communications medium.

28. The method of claim 27, further comprising:
filtering an output of the second serializer/deserializer with a low pass filter to create a low frequency envelope; and
subtracting the low frequency envelope from an input of the second serializer/deserializer.

29. A communications method, comprising:
sending a first data signal from a first electronic device to a first serializer/deserializer;
serializing the first data signal at the first serializer/deserializer, wherein a frequency of the serialized first data signal is within a first frequency band;
sending the serialized first data signal through an AC coupling of the first serializer/deserializer to a communications medium, wherein the AC coupling creates a forward channel on the communications medium;
receiving the serialized first data signal at a second serializer/deserializer, wherein the second serializer/deserializer is AC coupled to the communications medium;
sending a second data signal from a second electronic device to the second serializer/deserializer;
passing the second data signal through a reverse channel driver of the second serializer/deserializer when a frequency of the second data signal is within a second frequency band, wherein the second frequency band is lower than the first frequency band;
sending the second data signal through a DC coupling of the second serializer/deserializer to the communications medium, wherein the DC coupling creates a reverse channel on the communications medium; and
receiving the second data signal at the first serializer/deserializer, wherein the first serializer/deserializer is DC coupled to the communications medium.

30. The method of claim 29, comprising:
deserializing the first data signal at the second serializer/deserializer; and
forwarding the deserialized first data signal from the second serializer/deserializer to the second electronic device.
